(19) United States
(12) Patent Application Publication
(10) Pub. No.: US 2015/0095271 A1
(43) Pub. Date: Apr. 2, 2015

(54) METHOD AND APPARATUS FOR CONTEXTUAL LINEAR BANDITS

(71) Applicant: THOMSON LICENSING, Issy de Moulineaux (FR)

(72) Inventors: Stratis Ioannidis, San Francisco, CA (US); Jinyun Yan, Sunnyvale, CA (US); Jose Bento Ayres Pereira, Cambridge, MA (US)

(21) Appl. No.: 14/402,324

(22) PCT Filed: Jun. 14, 2013
(86) PCT No.: PCT/CN2013/077267

§ 371 Date: Nov. 20, 2014

Related U.S. Application Data
(60) Provisional application No. 61/662,631, filed on Jun. 21, 2012.

(51) Int. Cl. G06N 99/00; G06N 7/00

(52) U.S. Cl. CPC G06N 99/005; G06N 7/005
USPC 706/12

(57) ABSTRACT

A method of selection that maximizes an expected reward in a contextual multi-armed bandit setting gathers rewards from randomly selected items in a database of items, where the items correspond to arms in a contextual multi-armed bandit setting. Initially, an item is selected at random and is transmitted to a user device which generates a reward. The items and resulting rewards are recorded. Subsequently, a context is generated by the user device which causes a learning and selection engine to calculate an estimate for each arm in the specific context, the estimate calculated using the recorded items and resulting rewards. Using the estimate, an item from the database is selected and transferred to the user device. The selected item is chosen to maximize a probability of a reward from the user device.

### CROSS REFERENCE TO RELATED APPLICATION

This application claims priority to U.S. Provisional Application No. 61/662,631 entitled “Method and Apparatus For Contextual Linear Bandits”, filed on 21 Jun. 2012, which is hereby incorporated by reference in its entirety for all purposes.

### FIELD

The present invention relates generally to the application of sequential learning machines. More specifically, the invention relates to the use of contextual multi-armed bandits to maximize reward outcomes.

### BACKGROUND

The contextual multi-armed bandit problem is a sequential learning problem. At each time step, a learner has to chose among a set of possible actions/arms A. Prior to making its decision, the learner observes some additional side information x∈X over which he has no influence. This is commonly referred to as the context. In general, the reward of a particular arm a∈A under context x∈X follows some unknown distribution. The goal of the learner is to select arms so that it minimizes its expected regret, i.e., the expected difference between its cumulative reward and the reward accrued by an optimal policy that knows the reward distributions.

One prior art algorithm called epoch-Greedy can be used for general contextual bandits. That algorithm achieves an O(log T) regret in the number of timesteps T in the stochastic setting, in which contexts are sampled from an unknown distribution in an independent, identically distributed (i.i.d.) fashion. Unfortunately, that algorithm and subsequent prior art improvements have high computational complexity. Selecting an arm at time step t requires making a number of calls to a so-called optimization oracle that grows polynomially in T. In addition, implementing this optimization oracle can have a cost that grows linearly in |X| in the worst case; this is prohibitive in many interesting cases, including the case where |X| is exponential in the dimension of the context. In addition, both the epoch-Greedy and its improvement algorithms require keeping a history of observed contexts and arms chosen at every time instant. Hence, their space complexity grows linearly in T. Currently, these complexities are unaddressed in the prior art.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

The present invention includes a method and apparatus to maximizes an expected reward in a contextual multi-armed bandit setting. The method alternates between two phases; an exploration and an exploitation phase. The exploration phase includes a random selection of items in a database, the items corresponding to arms in the contextual multi-armed bandit setting, the selection of items independent of a context of the item. Transmitting the randomly selected items from a learning and selection engine to a user device, wherein the user device transmits rewards back to the learning and selection engine. The selected item and the corresponding rewards are recorded. In an exploitation phase, a context is received from a user device and an estimate for each arm in the specific context is calculated, the estimate calculated using the recorded items and rewards. An item responding to the context is selected and sent to the user device wherein the user device returns a reward. The item selected to maximize an expected reward from the user device. The method alternates between exploration and exploitation at random, selecting an exploration phase with a decreasing probability: as such, initially exploration phases dominate method operations but are eventually surpassed by exploitation phases.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 depicts a functional diagram of a learning and selection engine according to aspects of the invention;

FIG. 2 depicts a block diagram of a learning and selection engine having aspects of the present invention;

FIG. 3 depicts an on-line advertisement placement system as an example contextual multi-armed bandit solution setting according to aspects of the invention;

FIG. 4a depicts an example flow diagram of exploration epoch of contextual multi-armed bandit use according to aspects of the invention;

FIG. 4b depicts an example flow diagram of exploitation epoch of contextual multi-armed bandit use according to aspects of the invention; and

FIG. 5 depicts an example series of exploration and exploitation epochs according to aspects of the invention.

### DETAILED DISCUSSION OF THE EMBODIMENTS

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

The above challenges of implementing an optimization oracle and storage space complexity for contexts and arms in using prior art multi-armed bandits can be addressed when rewards are linear. In the above contextual bandit set up, this means that X is a subset of [symbol] ^{d}, and the expected reward of an arm a∈A is an unknown linear function of the context x, i.e., it has the form x^{†}θₐ, for some unknown vector θₐ. This is a case of great interest, arising naturally when, conditioned on x, rewards from different arms of the multi-armed bandit are uncorrelated.

One example application of a multi-armed bandit algorithm using aspects of the present invention is a problem involving processor scheduling. Consider assigning incoming jobs to a set of processors A, whose processing capabilities are not known a priori. This could be the case if the processors are machines in the cloud or alternatively, humans offering their services to perform tasks unsuited for pre-programmed machines, such as in a Mechanical Turk service. Each arriving job is described by a set of attributes x∈ [symbol] ^{d}, each capturing the work load of different types of sub-tasks this job entails, such as computation, I/O, network communication, etc. Each processor's unknown feature vector θₐ describes its processing capacity, that is, the time to complete a sub-task unit, in expectation. The expected time to complete a task x is given by x^{†}θₐ; otherwise stated as <xₜ, θₐ>, the goal of minimizing the delay (or, equivalently, maximizing its negation) brings us in the above multi-armed bandit problem setting.

Another example application of the multi-armed bandit algorithm using aspects of the present invention is a problem involving search-advertisement and placement. In this setup, users submit queries (such as “blue Nike™ shoes”) and the advertiser needs to decide which advertisement (“ad”) to show among advertisements (“ads”) in a set A. Ideally, the advertiser would like to show the ad with the highest “click-trough-rate”, i.e., the highest propensity of being clicked by the user, given the submitted query. Each query is mapped to a vector x in R^{d}, through a “map-to-tokens” method. In particular, each of the d coordinates of the vector x corresponds to a “token keyword”, such as “sports”, “shoe-ware”, “news”, “Lady Gaga”, etc. Using well-known algorithms the incoming query is mapped to such keywords with different weights, and the vector x captures the weight with which the query maps to, such as “sports”, “shoe-ware”, etc. Each ad a in A is associated with an unknown vector θₐ in R^{d}, capturing the propensity that when a given token is exhibited, the user will click the ad. The a priori unknown average click-through rate of an ad a for a query x is then given by <x, θₐ>.

Yet another example application of the multi-armed bandit algorithm using aspects of the present invention is a problem involving a group activity selection where the motivation is to maximize group ratings observed as the outcome of a secret ballot election. In this setup, a subset of d users congregate to perform a joint activity, such as dining, rock climbing, watching a movie, etc. The group is dynamic and, at each time-step t∈ [symbol] , the vector x∈{0,1}^{d}, is an indicator of present participants. An arm of the multi-armed bandit model (modeled as a joint activity) is selected; at the end of the activity, each user votes whether they liked the activity or not in a secret ballot, and the final tally is disclosed. In this scenario, the unknown vectors θₐ∈ [symbol] ^{d} indicate the probability a given participant will enjoy activity a, and the goal is to select activities that maximize the aggregate satisfaction among participants present at the given timestep.

Any of the above problems and model solutions can be accommodated using aspects of the invention. Characteristics and benefits of the present invention include the focus on a linear payoff case of stochastic multi-armed bandit problems, and a design of a simple arm selection policy which does not recourse to sophisticated oracles inherent in prior work. Another aspect is that the inventive aspects relate a policy achieves an O(log T) regret after T steps in the stochastic setting, when the expected rewards of each arm are well separated. This meets the regret bound of best known algorithms for contextual multi-armed bandit problems. Additionally, the inventive algorithm has O(|A|d²) computational complexity per step and its expected space complexity scales like O(|A|d²). This is a significant improvement over known contextual multi-armed bandit problems, as well as for bandits specialized for linear payoffs. In one aspect of the invention, modifications to the epoch-Greedy algorithm are performed as is the use of linear regression to estimate the parameters θₐ. One technical innovation is the use of matrix concentration bounds to control the error of the estimates of θₐ in the stochastic setting. This is a powerful realization and may ultimately help analyze richer classes of payoff functions.

Prior art concerning multi-armed bandits (bandits) assumes that, conditioned on the arm and the context, rewards are sampled from a probability distribution, p_{a,x}. As is common in bandit problems, there is a tradeoff between exploration, that is, the selection of arms a∈A to sample rewards from the distributions p_{a,x} and learn about them, and exploitation, whereby knowledge of these distributions based on the samples is used to select an arm that yields a high payoff. A significant challenge is that during the exploitation phase, conditioned on the fact that an arm a was chosen, the distribution of observed contexts does not follow p(x|a). In fact, an arm will tend to be selected more often in contexts in which it performs well. The prior art epoch-Greedy algorithm deals with this by separating the exploration and exploitation phase, effectively selecting an arm uniformly at random at certain time slots (the exploration “epochs”), and using samples collected only during these epochs to estimate the payoff of each arm in the remaining time slots (for exploitation). Prior art work has established a O(T^{2/3}(ln|X|)^{1/3}) on the regret for epoch-Greedy in the stochastic setting. It has been further improved to O(log T) when a lower bound on the gap between optimal and suboptimal arms in each context exists. Unfortunately, the price is high computational complexity when selecting an arm during an exploitation phase. In a recent prior art improvement, this computation requires a poly(t) number of calls to an optimization oracle. Most importantly, even in the linear case study discussed below, there is no clear way to implement the oracle in sub-exponential time in d, the dimension of the context.

Linear bandits have been extensively studied in the following general setup. In the classic linear bandit setup, the arms themselves are represented as vectors, i.e., A⊂ [symbol] ^{d}, and, in addition, the set A can change from one time slot to the next. The expected payoff of an arm a with vector xₐ is given by xₐ^{†}θ, for some unknown vector 0a∈^{d}, common among all arms.

In an adversarial setting, |A| is fixed (and finite) and A⊂ [symbol] ^{d} is given at each time by an adversary that has full knowledge of what the learner knows, but cannot a priori predict the outcome of any random variables before the learner observes them. In the stochastic setting, A is a fixed but possibly uncountable bounded subset of [symbol] ^{d}.

The regret bounds on all of the above setups (both stochastic and adversarial) are of the order of O(\sqrt{T}polylog (T)). An important distinction between the aforementioned general linear bandit setup and the contextual model is that in the above setting, different arms' payoffs are correlated. Payoffs observed for any arm inform the learner about the common unknown θ and, hence, help infer the payoff of a different arm. Exploiting this correlation to achieve low regret constitutes the main challenge of the above setups. In the above setups, the reward of an arm does not reveal any information about the reward of another arm. But, the reward observed when playing a certain arm under a given context gives information about the reward of the same arm under a different context. Nevertheless, the rewards for the same arm under different contexts are correlated. Exploiting this correlation to learn the unknown vectors θₐ faster and achieve low regret constitutes one goal of the present invention.

The contextual multi-armed bandit of the present invention can be expressed as a special case of the above linear bandit setup by taking θ=[θ₁; . . . ; θ_{K}]∈ [symbol] ^{Kd}, where K=|A|, and, given context x, associating the i-th arm with an appropriate vector of the form xₐ_{ᵢ}=[0 . . . x . . . 0]. As such, all of the above O(\sqrt{T}polylog (T)) bounds (and respective algorithms) can be applied to the present setup. However, prior art algorithms do not exploit the fact that, in the present invention setting, arms are uncorrelated. This aspect is exploited to obtain a logarithmic regret, for a much simpler algorithm than the ones outlined in the prior art.

A definition of the linear contextual bandit problem is now described. Concerning context, At every time instant t∈{1,2, . . . }, a context xₜ∈X⊂ [symbol] ^{d}, is observed by the learner. The learner is a learning engine computation device, typically a computer based machine running one or more algorithms. It is assumed that ∥x∥₂≦1; as the expected reward is linear in x, this assumption is without loss of generality (w.l.o.g.). One inventive result is expressed as Theorem 2 below in the stochastic setting where xₜ are drawn independently, and identically distributed (i.i.d.) from an unknown multivariate probability distribution D. In addition, the set of contexts is finite, that is |X|≦∞. Σₘᵢₙ>0 is defined to be the smallest non-zero eigenvalue of the covariance matrix Σ≡ [symbol] {x₁x₁^{†}}.

Concerning arms and actions of the multi-armed bandit, at time t, after observing the context xₜ, the learner engine decides to play an arm a∈A, where K≡|A| is finite. The arm played at this time is denoted by aₜ. Adaptive arm selection policies are studied, whereby the selection of aₜdepends only on the current context xₜ, and on all past contexts, actions and rewards. In other words, aₜ=aₜ(xₜ, {x_{τ}, a_{τ}, r_{τ}}_{τ=1}^{t-1}).

Concerning payoff, after observing a context xₜ and selecting an arm aₜ, the learner engine receives a payoff rₐ_{ₜ}_{,x}_{ₜ} which is drawn from a distribution pₐ_{ₜ}_{,x}_{ₜ} independently of all past contexts, actions or payoffs. The expected payoff is assumed to be a linear function of the context. In other words,

rₐ_{ₜ}_{,x}_{ₜ}=xₜ^{†}θₐ+∈_{a,t} (1)

where {∈_{a,t}}_{a∈A,t≧1} are a set of independent random variables with zero mean and {θₐ}_{a∈A} are unknown parameters in [symbol] ^{d}. Note that, w.l.o.g, it is assumed that Q=max_{a∈A}∥θₐ∥₂≦1. This is because if Q>1, as payoffs are linear, all payoffs can be divided by Q; the resulting payoff is still a linear model. Recall that Z is a sub-gaussian random variable with constant L if [symbol] {e^{γ}^{^{Z}}}≦e^{γ}^{²}^{L}^{²}. In particular, sub-gaussianity implies [symbol] {Z}=0.

The following technical assumption is made.
Assumption 1. The random variables {∈_{a,t}}_{a∈A,t≧1} are sub-gaussian random variables with constant L>0.

Concerning regret, given a context x, the arm that gives highest expected reward is

a*ₓ=_{a∈}x^{†}θₐ. (2)

Concerning regret, the expected cumulative regret the learner engine experiences over T steps is defined by,

$$R ( T ) = \{ {\sum }_{t = 1}^{T} {x}_{t}^{{ }^{†}} ( {θ}_{{a}_{{x}_{t}}^{*}} - {θ}_{{a}_{t}} ) \} . \qquad ( 3 )$$

The expectation above is taken over the contexts xₜ. The objective of the learner engine is to design a policy aₜ=aₜ(xₜ,{x_{τ},a_{τ},r_{τ}}_{τ=1}^{t-1}) that achieves as low expected cumulative regret as possible. It is also desirable to have low computational complexity. Defined are Δₘₐₓ≡max_{a,b∈A}∥θₐ−θ_{b}∥₂, and

$${Δ}_{m i n} ≡ {inf}_{x ∈ χ , a : {x}^{†} {θ}_{a} < {x}^{†} {θ}_{{a}_{x}^{*}}} {x}_{t}^{†} ( {θ}_{{a}_{{x}_{t}}^{*}} - {θ}_{a} ) > 0$$

Observe that, by the finiteness of χ and A, the above infimum is attained (i.e., it is a minimum) and is indeed positive.

Under the above assumptions, as an aspect of the invention, a simple and efficient on-line algorithm can be generated that has expected logarithmic regret. Specifically, its computational complexity, at each time instant, is O(Kd²) and the expected memory requirement scales like O(Kd²). The inventors believe that they are the first to show that a simple and efficient algorithm for the problem of linearly parameterized bandits can, under reward separation and i.i.d. contexts, achieve logarithmic expected cumulative regret.

Understanding the algorithm is aided by providing some intuition concerning it. Part of the job of the learner engine is to estimate the unknown parameters θₐ based on past actions, contexts and rewards. The estimate of θₐ at time t is denoted by \hat{θ}_{a,t}. If θₐ≈\hat{θ}_{a,t} then, given an observed context, the learner engine will more accurately know which arm to play to incur a small regret. The estimates θ_{a,t} can be constructed based on a history of past events. Such a history of past events is recorded as events of rewards, contexts, and arms played.

Since observing a reward r for arm a under context x does not give information about the magnitude of θₐ along directions orthogonal to x, it is important that, for each arm, rewards are observed and recorded for a rich class of contexts. This gives rise to the following challenge: If the learner engine tries to build this history while trying to minimize the regret, the distribution of contexts observed when playing a certain arm a will be biased and potentially not rich enough. In particular, when trying to achieve a small regret, conditioned on aₜ=a, it is more likely that xₜ is a context for which a is optimal.

This challenge is addressed using the following idea, which also appears in the epoch-Greedy algorithm. Time slots are partitioned into exploration and exploitation epochs. Algorithm operations differ depending on the type of epoch, and the algorithm alternates between exploration and exploitation. In exploration epochs, the learner engine plays arms uniformly at random, independently of the context, and records the observed rewards. This guarantees that in the history of past events, each arm has been played along with a sufficiently rich set of contexts. In exploitation epochs, the learner makes use of the history of events stored during exploration to estimate the parameters θₐ and determine which arm to play given a current observed context. The rewards observed during exploitation are not recorded.

More specifically, when exploiting, the learner engine performs two operations. In the first operation (operation 1), for each arm a∈A, an estimate \hat{θ}ₐ of θₐ is constructed from a simple l₂-regularized regression, as in the prior art. In the second operation (operation 2), the learner engine plays the arm a that maximizes the expected reward xₜ^{†}\hat{θ}ₐ. This operation is the dot product of the two vectors xₜ^{†} and \hat{θ}ₐ and may also be expressed as <xₜ^{†},\hat{θ}ₐ>. Crucially, in the first operation, only information collected during exploration epochs is used.

In particular, let T_{a,t-1} be the set of exploration epochs up to and including time t−1 (i.e., the times that the learner played an arm uniformly at random). Moreover, for any T∈ [symbol] , denoted by rT∈ [symbol] ⁿ is a vector of observed rewards for all time instances t∈T, and X_{T}∈ [symbol] ^{n×d} is a matrix of T rows, each containing one of the observed contexts at time t∈T. Then, at timeslot t the estimator \hat{θ}\hat{z}ₐ is the solution of the following convex optimization problem.

$${min}_{θ ∈ {ℝ}^{d}} \frac{1}{2 n} {‖ r - {X}_{T} θ ‖}_{2}^{2} + \frac{{λ}_{n}}{2} {‖ θ ‖}_{2}^{2} . \qquad ( 4 )$$

where T=T_{a,t-1}, n=|T_{a,t-1}|, λₙ=1/\sqrt{n}. In other words, the estimator θₐ is a (regularized) estimate of θₐ, based only on observations made during exploration epochs. Note that the solution to (4) is given by

$${\hat{θ}}_{a} = {( {λ}_{n} I + \frac{1}{n} {χ}_{T}^{†} {χ}_{T} )}^{- 1} \frac{1}{n} {χ}_{T}^{†} {r}_{T} \qquad ( 5 )$$

Algorithm 1: contextual epoch Greedy

```
For all a ∈ A, set Aₐ ← 0_{d×d} ;nₐ ← 0; bₐ ← 0_{d}
for t = 1 to p do
  a ← 1 + (t  mod K)
  Play arm a
  nₐ ← nₐ + 1: bₐ ← bₐ + rₜxₜ; Aₐ ← Aₐ + xₜxₜ^{†}
end for
for t = p + 1 to T do
  e ← Bernoulli(p/t)
  if e = 1 then (exploration phase)
    a ← Uniform (1/K)
    Play arm a
    nₐ ← nₐ + 1; bₐ ← bₐ + rₜxₜ; Aₐ ← Aₐ + xₜxₜ^{†}
  else (exploitation phase)
    for a ∈ A do
      ${\hat{θ}}_{a} ← {( {λ}_{na} I + \frac{1}{{n}_{a}} {A}_{a} )}^{- 1} \frac{1}{{n}_{a}} {b}_{a} ( operation 1 )$
    end for
    Play arm a = arg max_{b}xₜ^{†}\hat{θ}_{b} (operation 2)
  end if
end for
```

The partition of time into exploration and exploitation epochs, i.e., the selection of the time slots at which the algorithm explores, rather than exploits, is of interest. The exploration epochs are selected so that they occur approximately Θ(log t) times in each t slots in total. This guarantees that, at each time step, there is enough information in the history of past events to determine the parameters accurately while only incurring in a regret of O(log t). There are several ways of achieving this; algorithm 1 explores at each time step with probability Θ(t⁻¹) occurring at time ct₀, c>1, where t₀ is the time of the last exploration. In particular, it generates a random bit from a Bernoulli distribution with parameter p/t, and explores if the outcome is 1. Put differently, an epoch t>p is an exploration epoch with probability p/t.

The above steps are summarized in pseudocode by Algorithm 1. Note that the algorithm contains a scaling parameter p, which is specified below in Theorem 2. Because there are K arms and for each arm (xₜ, r_{a,t})∈ [symbol] ^{d+1}, the expected memory required by the algorithm scales like O(pKdlog t). In addition, both the matrix X_{T}^{†}X_{T} and the vector X_{T}^{†}r_{T} can be computed in an online fashion in O(d²) time: X_{T}^{†}X_{T}←X_{T}^{†}X_{T}+xₜx_{T}^{†} and X_{T}^{†}X_{T}←X_{T}^{†}X_{T}+rₜxₜ. Finally, the estimate of \hat{θ}ₐ involves solving a linear system, which can be done in O(d²) time. The above is summarized in the following theorem,

Theorem 1. Algorithm 1 has computational complexity of O(Kd²) and its expected space complexity scales like O(pKd log T).

The main theorem that shows that Algorithm 1 achieves R(T)=O(log T) is as follows:

Theorem 2. Under Assumption 1, the expected cumulative regret of Algorithm 1 satisfies,

$$R ( T ) \leq p {Δ}_{ma x} \sqrt{d} + 14 {Δ}_{ma x} \sqrt{d} K {e}^{Q / 4} + p {Δ}_{ma x} \sqrt{d} log T . \\ for any \\ p \geq \frac{{CKL}^{′ 2}}{{( {Δ}_{m i n}^{′} )}^{2} {( {\sum }_{m i n}^{′} )}^{2}} . \qquad ( 6 )$$

Above, C is a universal constant, Δ′ₘᵢₙ=min{1,Δₘᵢₙ}, Σ′ₘᵢₙ=min{1,Σ_{min}} and L′=max{1,L}.

Algorithm 1 requires the specification of the constant p. This is related to parameters that are a priori unknown, namely Δₘᵢₙ, Σₘᵢₙ, and L. In practice, it is not hard to estimate these and hence find a good value for p. For example, Σₘᵢₙcan be computed from [symbol] {xₜxₜ^{†}}, which can be estimated from the sequence of observed xₜ. The constant L can be estimated from the variance of the observed rewards. Finally, Δₘᵢₙ can be estimated from the smallest average difference of observed rewards among close enough contexts.

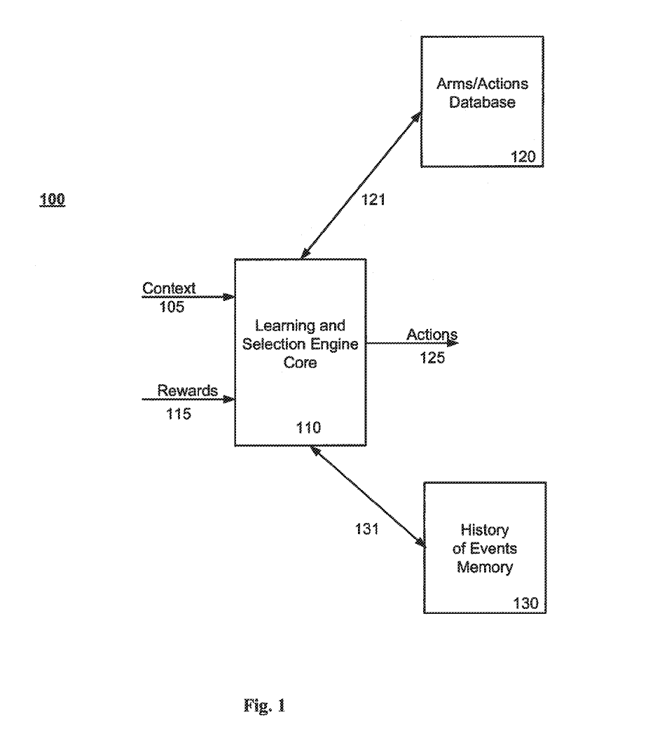

Having the algorithmic basis for a method of selection that minimizes a regret parameter, an example application is discussed. FIG. 1 presents a function diagram 100 of a learning and selection engine according to aspects of the invention. The learning engine 100 includes a core engine 110 which acts to perform computations associated with the execution of algorithm 1. Inputs to the learning engine core include context 105 and observed rewards 115. Outputs of the core include actions 125 resulting from selection of arms within the multi- armed bandit. Also illustrated in FIG. 1 are an arms/actions database 120 and a history of events memory 130 which is a storage area for arm/actions played, corresponding rewards, and contexts. The arms/actions database is storage of various arms or actions that the leaning and selection engine 110 can take as a result of processing within algorithm 1. In the exploration epoch, the learning engine 110 accesses the arms/actions database uniformly at random, independent of the input context, and records the results in the history of events memory 130. In the exploitation epoch, upon calculations of an expected value of a reward for a certain context, the learning engine can access the arms/actions database via link 121 to retrieve instructions concerning the execution of an action representing a specific selected arm to play as a result of the context and prior rewards recorded in the exploration epoch. The learning and selection engine 110 can access the history of events memory 130 via link 131 to assist in the calculation of maximizing the probability of a reward for a given context. Links 120 and 131 may be implemented in any fashion known to those of skill in the art. In one embodiment, the arms/actions database 120 and the history of events memory 130 are included in the learning and selection engine 110. Alternately, either or both of the arms/actions database 120 or the history of events memory 130 may be external to the learning and selection engine.

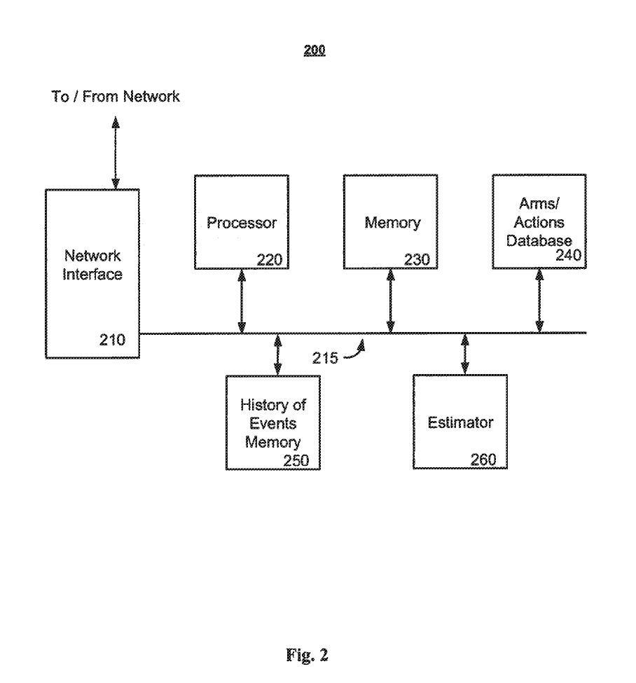

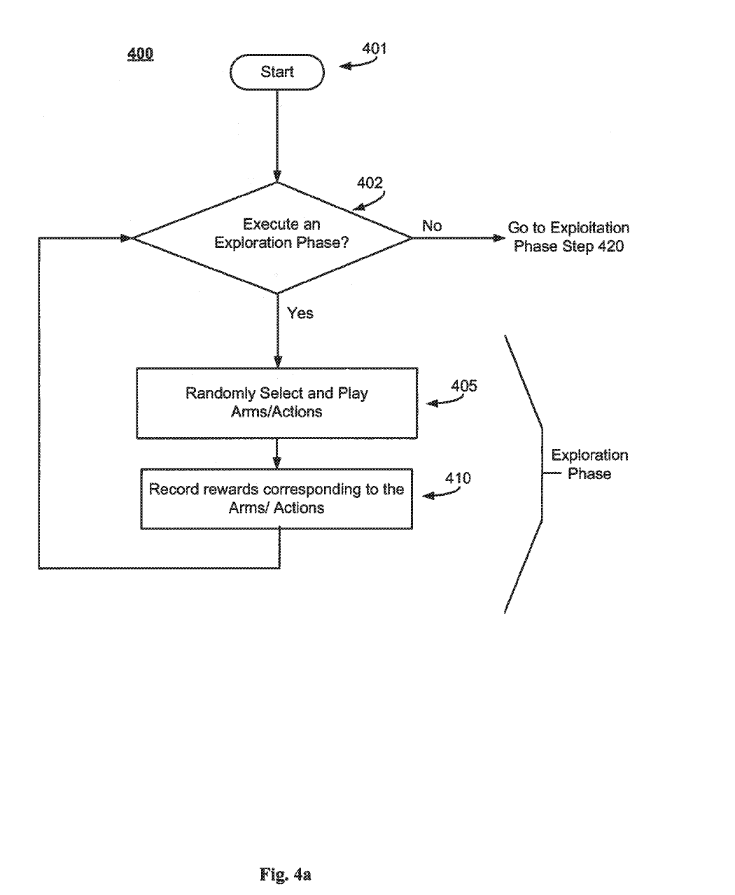

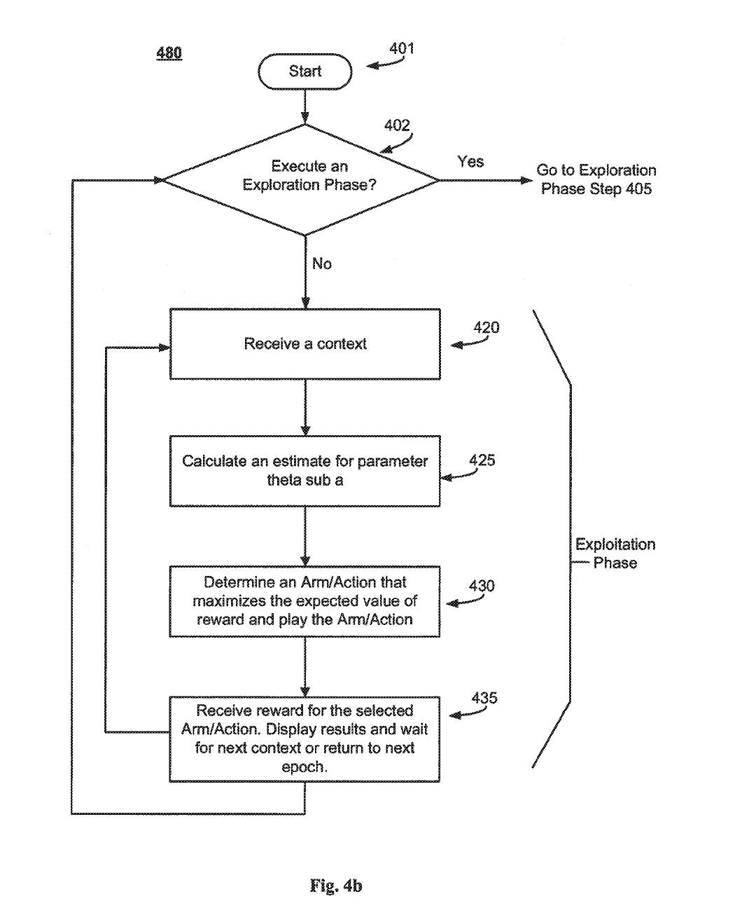

FIG. 2 is an example embodiment of a learning and selection engine that executes, among other things, algorithm 1 to maximize rewards in a multi-armed bandit solution apparatus for a given context input. The block diagram of a learning and selection engine 200 illustrated in FIG. 2 includes a network interface 210 which allows access to a private or public network, such as a corporate network or the Internet respectively, either via wired or wireless interface. Traffic on via network interface 210 includes but is not limited to receipts for requests from a user, and transmissions of arms/actions relating to exploration and exploitation phases to be discussed below with respect to FIG. 4.

Processor 220 provides computation functions for the learning and selection engine 200. The processor can be any form of CPU or controller that utilizes communications between elements of the learning and selection engine to control communication and computation processes for the engine. Those of skill in the art recognize that bus 215 provides a communication path between the various elements of engine 200 and that other point to point interconnection options instead of a bus architecture are also feasible.

Memory 230 can provide a repository for memory related to the method that incorporates algorithm 1. Memory 230 can provide the repository for storage of information such as program memory, downloads, uploads, or scratchpad calculations. Those of skill in the art will recognize that memory 230 may be incorporated all or in part of processor 220. Processor 220 utilizes program memory instructions to execute a method, such as method 400 of FIG. 4, to interpret received requests and data as well as to and to produce arm/selection data for transmission across the network interface 210. Network interface 210 has both receiver and transmitter elements for network communication as known to those of skill in the art.

In the exploration phase, the learning and selection engine 200, using processor 220 selects at random, arms of the multi-armed bandit model from the arms/actions database 240. The selected arm/action is provided to the network interface 210 for transmission by the network interface transmitters across the network. Results of the transmitted actions are received by the network interface receivers and are routed, under control of the processor 220 to the history of events memory 250. The history of events memory 250 acts to store results of actions that are taken in the exploration phase. Later, those results are used in conjunction with the estimator 260, under the program guidance of the processor 220 to determine which action to take when a request for an action is received in the exploitation phase.

The estimator 260, which performs computations under the direction of processor 220, is depicted as a separately bused module in FIG. 2. However, those of skill in the art will recognize that the estimator may be either hardware based or a combination of hardware and software or firmware, such as a dedicated processor performing estimator functions. In addition, estimator 260 may be a separate item as shown or may be integrated into one or more components, such as processor 220.

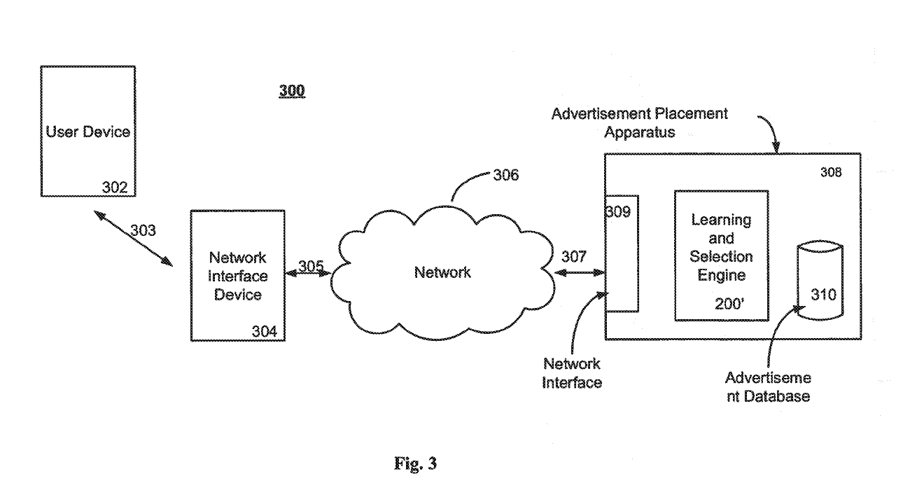

The learning and selection engine of FIGS. 1 and 2 are suited to accommodate the solutions for many contextual multi-armed bandit problem setups. As previously mentioned, the multi-armed bandit environment is useful in the solution of processor scheduling, search and advertisement placement, and group selection activity. As an example of such solution, FIG. 3 depicts a system addressing the search and advertisement placement embodiment. FIG. 3 depicts an on-line advertisement placement example where a contextual multi-armed bandit approach is implemented. The advertisement items can include ads for products and services where selection of an item of advertisement is one task of the contextual multi-armed bandit solution.

In terms of connectivity, a user, controlling user device 302, such as a laptop, tablet, workstation, cell phone, PDA, web-book, and the like, links 303 information, such as a search request, to a network interface device 304, such as a wireless router, a wired network interface module, a modem, a gateway, a set-top box, and the like. As is well known, the network interface device 304 could be built into the user device 302.

The network interface 304 connects to network 306 via link 305 and passes on the search request. Similar to link 303, link 305 may be wired or wireless. Network 306 can be a private or public network, such as a corporate network or the Internet respectively. The search request is communicated to the advertisement placement apparatus 308 having access to the learning and selection engine 200′ which is a modified version of learning and selection engine 200 having an additional interface to advertisement database 310.

Thus, in the configuration of FIG. 3, during an exploitation phase, a user interacts with user device 302 and inputs a search. The search is communicated through the network interface device 304, through network 306, through network interface 309, to advertisement placement apparatus 308. As is well known, the components of the advertisement placement apparatus can be grouped together as shown or they can be distributed in any manner.

Once at the advertisement selection engine, the user request is processed. The request can be any search request and, in this instance, may be a request for information, such as a Google™ search, a request for articles for sale, such as a search for products on Amazon™ or similar websites, and the like. The request is processed appropriately with context information, such as the parameters of the search, given to the learning and selection engine 200′. In the exploitation phase, the engine 200′ evaluates context information as well as past rewards using a multi-armed bandit solution and outputs an appropriate arm or action by selecting an advertisement from the advertisement database 310. The selected advertisement is then sent to the user device 302 via the transceiver (receiver/transmitter) of the interface network 309, though the network 306 and network interface device 304. The user views the advertisement, selected by the learning and selection engine 200′ to generate a maximum reward, and responds accordingly.

FIGS. 4a and 4b depict example flow diagrams of operation of a contextual multi-armed bandit use according to aspects of the invention. The example flow 400 of FIG. 4a is exemplary of an exploration phase or epoch. This is training or learning phase for the learning and selection engine. The example flow 480 of FIG. 4b is exemplary of an exploitation phase or exploitation epoch. In both FIGS. 4a and FIG. 4b, a new cycle begins at step 401. In both FIG. 4a and FIG. 4b, step 402 determines whether to execute an exploration phase or epoch. For example, using algorithm 1, if t>p, then an exploration phase or epoch is determined. If the learning engine determines that an exploration phase is to be executed, then flow 400 of FIG. 4a is used. If an exploration phase is not to be executed as determined at step 402, then an exploitation phase or epoch is to be executed according to flow 480 of FIG. 4b. In one aspect of the invention, the exploration phase or epoch can be executed independently of the exploitation phase or epoch. Normally, these epochs can follow one another in time sequence.

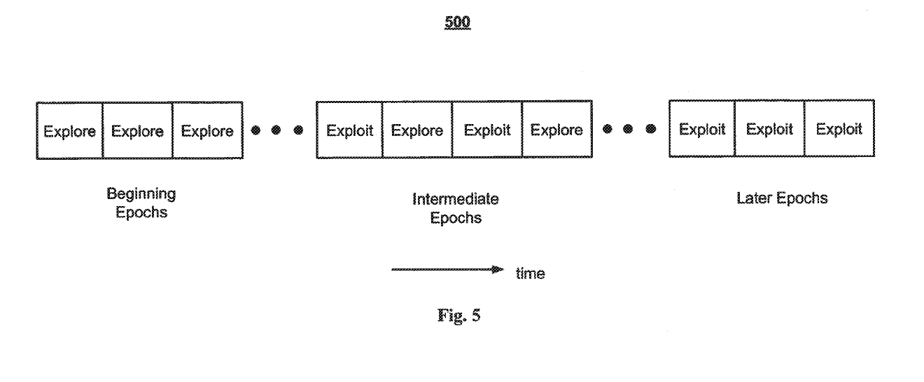

FIG. 5 is a depiction of an example epoch series 500. In the beginning of a new cycle of epochs, exploration epochs or phases occur with greater probability and thus occur more frequently than exploitation epochs. In intermediate epochs, both exploration and exploitation epochs can occur with roughly the same probability or approximately with the same frequency. In later epochs, exploitation epochs tend to occur with greater probability and thus with greater frequency than exploration epochs.

Returning to FIG. 4a, given that the exploration phase is to be executed, step 402 moves to step 405. In the exploration phase, the learning and selection engine 200′ gathers information according to algorithm 1. In step 405, the learning and selection engine plays arms/actions uniformly at random, independent of any context that is input by a user device, and records the observed rewards. The arms/actions played by the learning and selection engine 200′ within the advertisement placement apparatus 308 are transmitted to a user device 302 via the network 306. In the instance of a search and advertisement placement application of algorithm 1, the arms/actions are advertisements sent to the user device 302. In step 410, the rewards corresponding to the played arms/actions are recorded. As part of step 410, the user responds to the advertisements and thus provides rewards back to the learning and selection engine 200′ via the network 306. The arms/actions played and the corresponding rewards that are received are recorded in a history of events memory accessible to the learning and selection engine 200′. The random playing of arms/actions in step 405 and the recording of corresponding received rewards in step 410 provide a sufficiently rich set of contexts for the learning and selection engine. Step 410 then returns to step 402 for a determination if the next epoch is an exploration or an exploitation epoch.

If an exploitation epoch is to be executed at step 402, then the flow of FIG. 4b is used. At step 420, the exploitation epoch or phase begins. At step 420, a context is input into the learning and selection engine 200′. This context input is essentially a user input transferred from user device 302, through the network 306, and received by the learning and selection engine 200′ of the advertisement placement apparatus 308. In the embodiment of advertisement placement application of algorithm 1, the context input is a search performed by a user utilizing user device 302. At step 425, the learning and selection engine 200′ makes use of the history of events stored during exploration to calculate an estimate \hat{θ}ₐ of the parameter θₐ (theta sub a). This is operation 1 of algorithm 1. In this first operation, an estimate \hat{θ}ₐ is performed for each arm and may be performed using a regularized regression. At step 430, the learning and selection engine 200′ and determines which arm/action to play given the current received context from the user device and the calculated estimates. The determination being an arm/action that maximizes the expected value of reward. This also represents a minimization of regret. In the setting of an advertisement placement, the maximized expected reward is an advertisement selected such that a user operating a user device responds to the advertisement in a positive manner with high probability. One such positive manner response is a user placing an order for the product or service represented by the selected advertisement via the user device.

Also at step 430, the determined arm/action is played. In the setting of an advertisement placement, as shown in FIG. 3, the arm/action is the selection of an appropriate advertisement from a database of advertisements 310. The selected advertisement is sent to the user device from the advertisement placement apparatus 308 to the user device 302 via the network 306. At step 435, a reward from the user device is received by the learning and selection engine. The learning and selection engine may optionally pass on the reward for display on a monitor device (not shown) for the display of the reward or a set of received cumulative rewards. The monitor may be part of the advertisement placement apparatus or may be part of a system attached to the advertisement placement apparatus.

Alternately, the reward, which may be a response to the advertisement sent in the advertisement embodiment, may be further processed by an advertisement response system (not shown) which can involve displaying the reward or response. Also, at step 435, the advertisement placement apparatus 308 having the learning and selection engine 200′ waits for a new context from the user device 302 to be input to the advertisement placement apparatus 308 before moving back to step 420 where that context is input into the learning an selection engine. This last step begins a new exploitation phase. It is well to note that responses to the placed advertisement, i.e. rewards, are not recorded during the exploitation steps. If no new context is available at step 435, then the end of the exploitation epoch is reached and the flow 480 moves back to step 402 to await the determination of the next type of epoch.

Although specific architectures are shown for the implementation of a mechanism that performs a contextual multi-armed bandit solution, one of skill in the art will recognize that implementation options exist such as distributed functionality of components, consolidation of components, and location in a server as a service to users. Such options are equivalent to the functionality and structure of the depicted and described arrangements.

1. A method of selection that maximizes an expected reward in a contextual multi-armed bandit setting, the method comprising:
(a) training a learning and selection engine having access to a plurality of items corresponding to arms in the contextual multi-armed bandit setting;
(b) receiving, by the learning and selection engine from a user device, a context in which to select one item from a plurality of items, the plurality of items corresponding to arms in the contextual multi-armed bandit setting;
(c) calculating an estimate for each arm in the context, the estimate calculated using a history of past events;
(d) selecting an arm that maximizes the expected reward;
(e) providing a selection item corresponding to the selected arm for the context received, the selection item transferred to the user device; and
(f) receiving and displaying a reward, sent by the user device to the learning and selection engine.

2. The method of claim 1, wherein receiving a context in which to select a specific one of the selection items comprises receiving a search query from the user device.

3. The method of claim 1, wherein selecting an arm that maximizes the expected reward comprises selecting an advertisement that maximizes the probably of a positive response.

4. The method of claim 1, wherein selecting an arm that maximizes the expected reward comprises minimizing a regret parameter.

5. The method of claim 1, wherein receiving and displaying a reward, sent by the user device to the learning and selection engine comprises receiving a response from the user device to a selected advertisement, wherein the response is available for display on a monitor.

6. The method of claim 1, wherein training the learning and selection engine further comprises:
randomly selecting items from a plurality of items, the plurality of items corresponding to arms in the contextual multi-armed bandit setting, the random selection of items independent of a context of the item;
transmitting the randomly selected items from the learning and selection engine to the user device, wherein the user device transmits rewards back to the learning and selection engine; and
recording the rewards received by the learning and selection engine, the rewards corresponding to the items selected and recorded in memory, the memory containing a history of past events.

7. The method of claim 6, wherein randomly selecting items comprises randomly selecting advertisements for products or services.

8. The method of claim 7, wherein recording the rewards received by the learning and selection engine comprises recording responses from the user device to the randomly selected advertisements for the products or services.

9. The method of claim 6, wherein transmitting the randomly selected items from a learning and selection engine comprises transmitting the randomly selected items from a learning and selection engine which is part of an advertisement placement apparatus.

10. An apparatus to provide a selection from multiple items that maximizes an expected reward in a contextual multi-armed bandit setting, the apparatus comprising:
a processor that acts to randomly select an item from the multiple items, the multiple items corresponding to arms in the contextual multi-armed bandit setting, the selection of the item independent of a context of the item;
a network interface that transfers the randomly selected item to a user device, wherein the user device transmits rewards back to the network interface;
a memory for recording the rewards received by the network interface, the rewards corresponding to the item selected and recorded in the memory;
a receiver of the network interface for receiving a context;
wherein the processor acts to calculate an estimate for each arm in the received context, the estimate calculated using the rewards recorded in the memory, select an arm that maximizes the expected reward, provide a selection item corresponding to the selected arm for the received context;
wherein the selection item is transferred to the user device, and the apparatus receives a reward, sent by the user device.

11. The apparatus of claim 10, wherein the processor that acts to randomly select an item from the multiple items comprises a processor with access to an advertisement database that selects advertisements to send to the user device.

12. The apparatus of claim 10, wherein the processor is a component of a learning and selection engine of an advertisement placement apparatus.

13. The apparatus of claim 10, wherein the memory for recording the rewards comprises a memory that records responses from the user device to randomly selected advertisements for products or services.

14. The apparatus of claim 10, wherein the receiver of the network interface receives a search query from the user device as a context.

15. The apparatus of claim 10, wherein the reward, sent by the user device to a learning and selection engine comprises receiving a response from the user device to a selected advertisement.
